(19) United States
(12) Patent Application Publication
(10) Pub. No.: US 2010/0079514 A1
(43) Pub. Date: Apr. 1, 2010

(54) LIQUID SUPPLY DEVICE, IMAGE FORMING DEVICE, AND COMPUTER READABLE MEDIUM

(75) Inventor: Hiroshi SHIBATA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/541,980

(22) Filed: Aug. 17, 2009

(30) Foreign Application Priority Data
Sep. 29, 2008 (JP) 2008-251322

(51) Int. Cl. B41J 2/195; G05D 16/00

(52) U.S. Cl. 347/7; 137/82

(57) ABSTRACT

In a liquid supply device, a liquid chamber and an air chamber of a storage tank are demarcated by an elastic film, a pressure sensor detects pressure within the liquid chamber, and a supply pump supplies liquid to a supply destination via the liquid chamber. First information, that expresses a supply amount per predetermined time and a pressure of the liquid chamber within a range of not being affected by changes over time in the elastic film, is stored in a memory. A controller adjusts detected pressure by adjustment values, and controls the supply pump such that an adjusted pressure becomes constant at a predetermined pressure. The controller controls the supply pump such that there becomes a supply amount that is substantially the same as a supply amount of the first information, and acquires pressure detected at that time as second information, and derives the adjustment values on the basis of an offset amount between pressures of the first information and the second information.

### CROSS-REFERENCE TO RELATED APPLICATION

This application claims priority under 35 USC 119 from Japanese Patent Application No. 2008-251322 filed on Sep. 29, 2008 the disclosure of which is incorporated by reference herein.

### BACKGROUND OF THE INVENTION

1. Field of the Invention

The present invention relates to a liquid supply device, an image forming device, and a computer readable medium on which is recorded a program for the liquid supply device. In particular, the present invention relates to a liquid supply device that supplies liquid from a tank in which the liquid is stored to a supply destination, and to a computer readable medium on which is recorded a program for the liquid supply device, and to an image forming device that forms an image on a recording medium by using liquid supplied from the liquid supply device.

2. Description of the Related Art

There are conventionally known image forming devices (so-called inkjet printers) having tanks that store liquids such as inks and processing liquids and the like, and print heads that eject the liquids that are within the tanks. The image forming device is structured such that the tanks are provided separately from the print heads, and the supplying of liquids from the tanks to the print heads is carried out successively.

Japanese Patent Application Laid-Open (JP-A) No. 2006-21383 discloses the technique of setting a sub-tank, at whose interior an elastic film is provided, between the tank and the print head as a damper for absorbing pressure fluctuations, and sensing the pressure within the sub-tank by a pressure sensor. On the basis of the ink remaining amount that is sensed by the pressure sensor, control is carried out such that ink is fed to the sub-tank. Due to the elastic film in the sub-tank absorbing fluctuations in pressure and maintaining negative pressure, highly-viscous ink can be used.

### SUMMARY OF THE INVENTION

The present invention has been made in view of the above circumstances and provides a liquid supply device, an image forming device, and a computer readable medium on which is recorded a program for the liquid supply device.

According to an aspect of the invention, there is provided a liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; a controller that, when the liquid is supplied to the supply destination by the supply pump, adjusts pressure detected by the pressure sensor by adjustment values that are derived in advance, and controls the supply pump such that an adjusted pressure becomes constant at a predetermined pressure; and a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film, wherein the controller controls the supply pump such that there becomes a supply amount that is substantially the same as a supply amount of the first information, and acquires, as second information, a pressure detected by the pressure sensor at that time, and derives the adjustment values on the basis of an offset amount between pressures of the first information and the second information.

According to another aspect of the invention, there is provided a liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; a controller that, when the liquid is supplied to the supply destination by the supply pump, controls the supply pump such that a pressure detected by the pressure sensor becomes constant at a predetermined pressure; a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount; an acquisition unit acquiring elasticity curve information that includes a range that is not affected by changes over time in the elastic film and ranges that are affected, by acquiring a pressure detected by the pressure sensor at a time when the supply amount per predetermined time of the liquid by the supply pump is changed; a detection unit detecting, as second inflection points, boundary points between the range that is not affected by changes over time in the elastic film and the ranges that are affected, from the elasticity curve information acquired by the acquisition unit; and a specifying unit specifying a state of changes over time in the elastic film, on the basis of a state of offset between the first inflection points and the second inflection points.

According to another aspect of the invention, there is provided an image forming device including a liquid supply device that includes: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; a controller that, when the liquid is supplied to the supply destination by the supply pump, adjusts pressure detected by the pressure sensor by adjustment values that are derived in advance, and controls the supply pump such that an adjusted pressure becomes constant at a predetermined pressure; and a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film, wherein the controller controls the supply pump such that there becomes a supply amount that is substantially the same as a supply amount of the first information, and acquires, as second information, a pressure detected by the pressure sensor at that time, and derives the adjustment values on the basis of an offset amount between pressures of the first information and the second information.

According to another aspect of the invention, there is provided an image forming device including a liquid supply device that includes: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; a controller that, when the liquid is supplied to the supply destination by the supply pump, controls the supply pump such that a pressure detected by the pressure sensor becomes constant at a predetermined pressure; a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount; an acquisition unit acquiring elasticity curve information that includes a range that is not affected by changes over time in the elastic film and ranges that are affected, by acquiring a pressure detected by the pressure sensor at a time when the supply amount per predetermined time of the liquid by the supply pump is changed; a detection unit detecting, as second inflection points, boundary points between the range that is not affected by changes over time in the elastic film and the ranges that are affected, from the elasticity curve information acquired by the acquisition unit; and a specifying unit specifying a state of changes over time in the elastic film, on the basis of a state of offset between the first inflection points and the second inflection points.

According to another aspect of the invention, there is provided a computer readable medium storing a program causing a liquid supply device to execute a process, the liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film, the process including: controlling the supply pump such that there becomes a supply amount that is substantially the same as a supply amount of the first information, and acquiring, as second information, a pressure detected by the pressure sensor at that time; deriving adjustment values in accordance with an offset amount between pressures of the first information and the second information; when the liquid is supplied to the supply destination by the supply pump, adjusting pressure detected by the pressure sensor by the adjustment values; and controlling the supply pump such that a pressure after adjustment becomes constant at a predetermined pressure.

According to another aspect of the invention, there is provided a computer readable medium storing a program causing a liquid supply device to execute a process, the liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount, the process including: acquiring elasticity curve information that includes a range that is not affected by changes over time in the elastic film and ranges that are affected, by acquiring a pressure detected by the pressure sensor at a time when the supply amount per predetermined time of the liquid by the supply pump is changed; detecting, as second inflection points, boundary points between the range that is not affected by changes over time in the elastic film and the ranges that are affected, from the acquired elasticity curve information; and specifying a state of changes over time in the elastic film, on the basis of a state of offset between the first inflection points and the second inflection points.

According to another aspect of the invention, there is provided a computer readable medium storing a program causing a computer to execute a process, the computer controlling a liquid supply device, the liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film, the process including: controlling the supply pump such that there becomes a supply amount that is substantially the same as a supply amount of the first information, and acquiring, as second information, a pressure detected by the pressure sensor at that time; deriving adjustment values in accordance with an offset amount between pressures of the first information and the second information; when the liquid is supplied to the supply destination by the supply pump, adjusting pressure detected by the pressure sensor by the adjustment values; and controlling the supply pump such that a pressure after adjustment becomes constant at a predetermined pressure.

According to another aspect of the invention, there is provided a computer readable medium storing a program causing a computer to execute a process, the computer controlling a liquid supply device, the liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount, the process including: acquiring elasticity curve information that includes a range that is not affected by changes over time in the elastic film and ranges that are affected, by acquiring a pressure detected by the pressure sensor at a time when the supply amount per predetermined time of the liquid by the supply pump is changed; detecting, as second inflection points, boundary points between the range that is not affected by changes over time in the elastic film and the ranges that are affected, from the acquired elasticity curve information; and specifying a state of changes over time in the elastic film, on the basis of a state of offset between the first inflection points and the second inflection points.

### BRIEF DESCRIPTION OF THE DRAWINGS

Preferred embodiments of the present invention will be described in detail based on the following figures, wherein:

FIG. 1 is a sectional side view showing the structure of an inkjet recording device relating to an exemplary embodiment;

FIG. 2 is a schematic side view showing the internal structure relating to an ink supply system of the inkjet recording device relating to the exemplary embodiment;

FIG. 3 is a block diagram showing the system structure of the inkjet recording device relating to the exemplary embodiment;

FIG. 4 is a flowchart showing the flow of processing of an adjustment value deriving processing program relating to the exemplary embodiment;

FIG. 5 is a flowchart showing the flow of processing of a liquid feed control program relating to the exemplary embodiment;

FIG. 6 is a flowchart showing the flow of processing of an elastic film state detecting processing program relating to the exemplary embodiment;

FIG. 7 is a schematic drawing showing an example of information expressing the state of an elastic film that is displayed on a display section due to execution of the elastic film state detecting processing program relating to the exemplary embodiment;

FIG. 8 is a drawing for explaining a modified example of the exemplary embodiment, and is a schematic side view showing the internal structure relating to an ink supply system of the modified example;

FIG. 9 is a drawing for explaining a modified example of the exemplary embodiment, and is a schematic side view showing internal structures relating to an ink supply system and an ink recovery system of the modified example;

FIG. 10A and FIG. 10B are drawings for explaining the principles of the present invention; and

FIG. 11A and FIG. 11B are drawings for explaining the principles of the present invention.

### DETAILED DESCRIPTION OF THE INVENTION

In the technique disclosed in above-described JP-A No. 2006-21383, there are cases in which the output value of the pressure sensor becomes offset from the actual value due to changes over time in the pressure sensor. In such cases, the feed amount of the liquid cannot be controlled with high accuracy.

Further, in the above-described technique, there are cases in which the pressure within the sub-tank cannot be made to be the desired pressure due to changes over time in the slack state of the elastic film. In such cases as well, the feed amount of the liquid cannot be controlled with high accuracy.

The present invention provides a liquid supply device, an image forming device, and a computer readable medium on which is recorded a program for the liquid supply device, that can control the feed amount of a liquid with high accuracy.

In accordance with a first aspect of the present invention, there is provided a liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; a controller that, when the liquid is supplied to the supply destination by the supply pump, adjusts pressure detected by the pressure sensor by adjustment values that are derived in advance, and controls the supply pump such that an adjusted pressure becomes constant at a predetermined pressure; and a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film, wherein the controller controls the supply pump such that there becomes a supply amount that is substantially the same as a supply amount of the first information, and acquires, as second information, a pressure detected by the pressure sensor at that time, and derives the adjustment values on the basis of an offset amount between pressures of the first information and the second information.

The principles of the present invention will be described here.

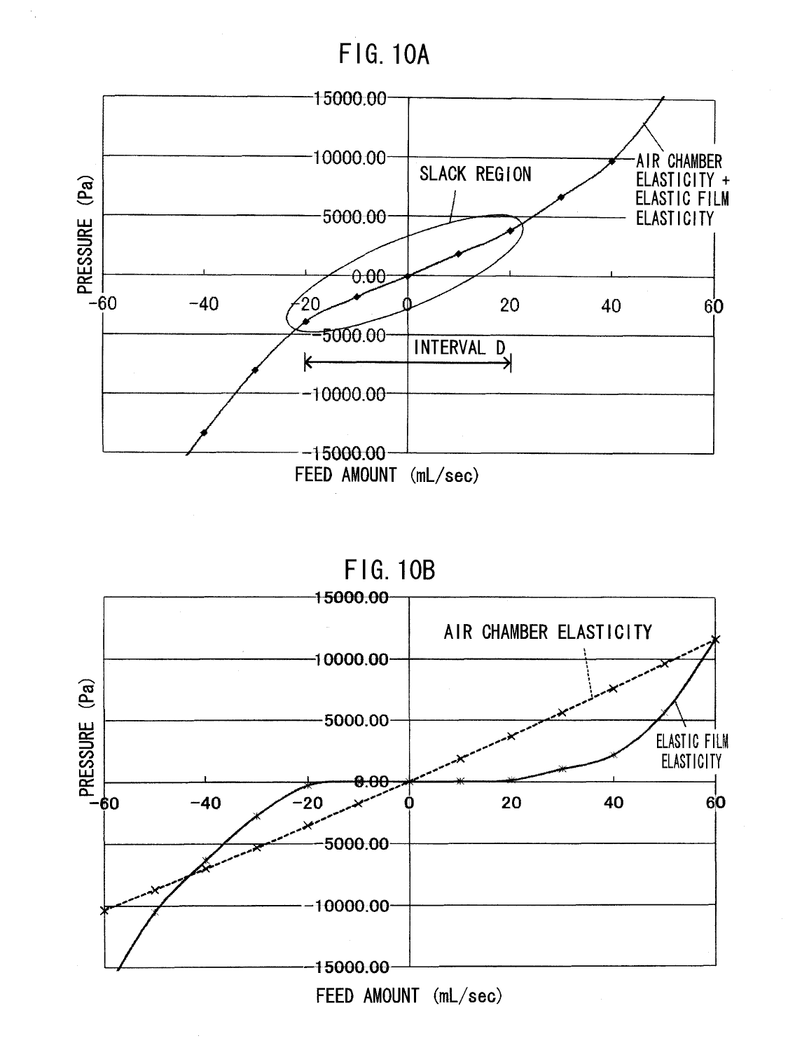

The storage tank relating to the present invention has an elastic film that is elastically deformable and is for demarcating a liquid chamber and an air chamber. An example of an elasticity curve at the storage tank, that shows the relationship between the supply amount of liquid to the liquid chamber per predetermined time and the pressure of the liquid chamber, is shown in FIG. 10A.

The elasticity curve is sectioned into two regions that are a region that is a substantially straight line including the point where the feed amount and the pressure of the liquid chamber are 0 (zero) (hereinafter called a “first region”), and regions that are curves positioned at the both ends of the first region (hereinafter called “second regions”).

As shown in FIG. 10B, the first region shown in FIG. 10A is a region where the elastic film is slack, and is a region that is not affected by the elasticity of the elastic film. This region will be called the “slack region” hereinafter.

The slack region is a region that is not affected even if the elastic film hardens or softens over time from its initial state. Therefore, in a case in which offset arises in the slack region of the elasticity curve of the storage tank that is obtained by detecting the pressure of the liquid chamber of the storage tank, this offset is expressed as offset from the correct value of the results of detection due to changes over time in the pressure sensor that is used in detecting the pressure.

Focusing on the above-described point, in accordance with the first aspect of the present invention, when the liquid is supplied to a predetermined supply destination by the supply pump, the controller adjusts the pressure detected by the pressure sensor by adjustment values that are derived in advance, and controls the supply pump such that the adjusted pressure becomes constant at a predetermined pressure.

First information, that expresses the supply amount per predetermined time of the liquid by the supply pump and the pressure of the liquid chamber at the time when the liquid is supplied at that supply amount within a range of not being affected by changes over time in the elastic film, is stored in advance in the memory. The controller controls the supply pump such that there becomes a supply amount that is substantially the same as a supply amount included in the first information, and acquires, as second information, the pressure detected by the pressure sensor at that time, and derives the adjustment values on the basis of the offset amount between the pressures of the first information and the second information.

Due thereto, errors in the results of detection of the pressure sensor, that are caused by changes over time in the pressure sensor, can be suppressed. As a result, the feed amount of the liquid can be controlled with high accuracy.

In accordance with a second aspect of the present invention, the supply pump may include a metering pump. Due thereto, the feed amount of the liquid can be controlled with even higher accuracy.

In accordance with a third aspect of the present invention, the liquid supply device may further include a metering unit that is disposed between the supply pump and the storage tank, and that makes a feed amount per predetermined time of liquid supplied by the supply pump be uniform at a preset amount. Due thereto, the feed amount of the liquid can be controlled with even higher accuracy.

The pressure sensor that detects the pressure generally outputs the detected pressure as a voltage value. Therefore, this voltage value must be converted into a pressure value.

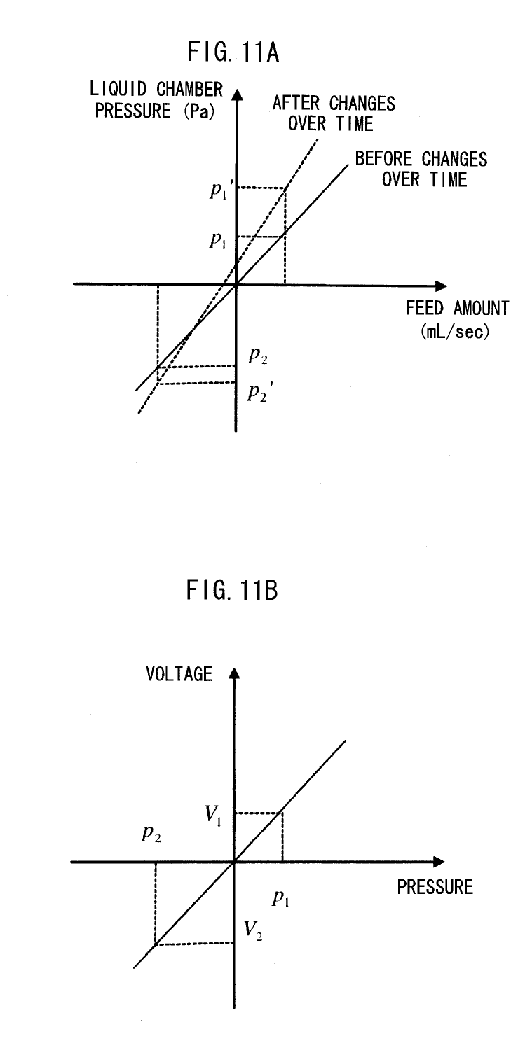

Changes, that accompany changes over time of the pressure sensor, in a slack region (a region not affected by changes over time in the elasticity of the elastic film) in an elasticity curve that is obtained on the basis of results of detection by the pressure sensor, are manifested as changes in at least one of the slope and the overall pressure value, as shown as an example in FIG. 11A.

The voltage value outputted from the pressure sensor and the pressure value expressed by that voltage value are in a proportional relationship, as shown as an example in FIG. 11B. Therefore, the calculation formula that converts the voltage value V into the pressure value p is shown by following formula (1).

p=αV+β (1)

In order to derive coefficient α and coefficient β in this calculation formula, first, the relationships between voltage values V₁ and V₂ at feed amounts of two points within a slack region of an elasticity curve that is based on voltage values obtained by the pressure sensor in a state before the pressure sensor has changed over time, and pressure values p₁ and p₂ corresponding thereto, are expressed by following formula (2) and formula (3).

p₁=αV₁+β (2)

p₂=αV₂+β (3)

The relationships between voltage values V₁′ and V₂′ that are outputted from the pressure sensor at the feed amounts of the aforementioned two points in a case in which the pressure sensor has changed over time, and pressure values p₁ and p₂ corresponding thereto, can be expressed by following formula (4) and formula (5) because the pressure values p₁ and p₂ are values of a region that is not affected by changes over time in the elastic film.

p₁=α′V₁′+β′ (4)

p₂=α′V₂′+β′ (5)

The following calculation formulas (formula (6) and formula (7)) are obtained as calculation formulas that derive α′ and β′, from the above simultaneous equations.

$$\begin{matrix}{α}^{′} = \frac{{p}_{1} - {p}_{2}}{{V}_{1}^{′} - {V}_{2}^{′}} & ( 6 ) \\ {β}^{′} = {p}_{1} - \frac{{p}_{1} - {p}_{2}}{{V}_{1}^{′} - {V}_{2}^{′}} {V}_{1}^{′} & ( 7 )\end{matrix}$$

In accordance with a fourth aspect of the present invention, the pressure sensor may be a sensor that outputs a voltage expressing a detected pressure, the first information may include the supply amounts of at least two points and pressures of the liquid chamber that correspond to those supply amounts, the controller may derive, as the adjustment values, α′ and β′ that are obtained by the following calculation formulas, where pressures of the liquid chamber corresponding to the two supply amounts in the first information are p₁ and p₂, and voltages outputted from the pressure sensor and corresponding to the two supply amounts in the second information are V₁′ and V₂′:

$$\begin{matrix}{α}^{′} = \frac{{p}_{1} - {p}_{2}}{{V}_{1}^{′} - {V}_{2}^{′}} & ( 8 ) \\ {β}^{′} = {p}_{1} - \frac{{p}_{1} - {p}_{2}}{{V}_{1}^{′} - {V}_{2}^{′}} {V}_{1}^{′} & ( 9 )\end{matrix}$$

and the controller may adjust pressure of the liquid chamber detected by the pressure sensor by substituting the derived adjustment values α′ and β′ into the following calculation formula, where a voltage detected by the pressure sensor is V and a pressure corresponding to that voltage V is p:

p=α′V+β′. (10)

In accordance with a fifth aspect of the present invention, the liquid supply device may further include: a second storage tank recovering, from the supply destination, and temporarily storing liquid except for liquid consumed by the supply destination; a second elastic film that is elastically-deformable and demarcates an interior of the second storage tank into a liquid chamber that stores the liquid and an air chamber into which air is filled; a second pressure sensor detecting pressure within the liquid chamber of the second storage tank; and a recovery pump recovering the liquid via the liquid chamber of the second storage tank, wherein the memory may also store in advance third information that expresses a recovery amount per predetermined time of the liquid by the recovery pump and a pressure of the liquid chamber of the second storage tank at a time when the liquid is recovered at that recovery amount, within a range of not being affected by changes over time in the second elastic film, and when the liquid is recovered by the recovery pump, the controller may adjust pressure detected by the second pressure sensor by second adjustment values that are derived in advance, and control the recovery pump such that an adjusted pressure becomes constant at a second pressure that is lower than the predetermined pressure, and, when deriving the second adjustment values, the controller may control the recovery pump such that there becomes a recovery amount that is substantially the same as a recovery amount included in the third information, and acquire, as fourth information, a pressure detected by the second pressure sensor at that time, and derive the second adjustment values on the basis of an offset amount between pressures of the third information and the fourth information. Due thereto, the feed amount of the liquid can be controlled with high accuracy even in a recovery system of the liquid.

In accordance with a sixth aspect of the present invention, the recovery pump may include a metering pump. Due thereto, the feed amount of the liquid can be controlled with even higher accuracy.

In accordance with a seventh aspect of the present invention, the liquid supply device may further include a second metering unit that is disposed between the recovery pump and the second storage tank, and that makes a feed amount per predetermined time of liquid recovered by the recovery pump be uniform at a preset amount. Due thereto, the feed amount of the liquid can be controlled with even higher accuracy.

In accordance with an eighth aspect of the present invention, the second pressure sensor may be a sensor that outputs a voltage expressing a detected pressure, the third information may include the recovery amounts of at least two points and pressures of the liquid chamber of the second storage tank that correspond to those recovery amounts, the controller may derive, as the adjustment values, α₂′ and β₂′ that are obtained by the following calculation formulas, where pressures of the liquid chamber of the second storage tank corresponding to the recovery amounts of the two points in the third information are p₃ and p₄, and voltages outputted from the second pressure sensor and corresponding to the recovery amounts of the two points in the fourth information are V₃′ and V₄′:

$$\begin{matrix}{α}_{2}^{′} = \frac{{p}_{3} - {p}_{4}}{{V}_{3}^{′} - {V}_{4}^{′}} & ( 11 ) \\ {β}_{2}^{′} = {p}_{3} - \frac{{p}_{3} - {p}_{4}}{{V}_{3}^{′} - {V}_{4}^{′}} {V}_{3}^{′} & ( 12 )\end{matrix}$$

and the controller may adjust pressure detected by the second pressure sensor by substituting the derived adjustment values α₂′ and β₂′ into the following calculation formula, where a voltage detected by the second pressure sensor is V₂ and a pressure corresponding to that voltage V₂ is p₂:

p₂=α₂′V₂+β₂′. (13)

In accordance with a ninth aspect of the present invention, the controller may derive the adjustment values at a predetermined timing. Due thereto, the adjustment values of the pressure can be updated whenever needed at an appropriate timing. As a result, the feed amount of the liquid can be controlled with even higher accuracy.

The predetermined timing may be each predetermined time period such as each month, each half-year, or the like, or the time when the power source is turned on, the time when maintenance is carried out, or the like.

At the elasticity curve of the storage tank, due to changes over time in the elastic film that is provided in the storage tank, the positions of the inflection points between a region that is not affected by changes over time in the elastic film (a slack region) and regions that are affected, become offset. More specifically, the softer the elastic film becomes, the wider the interval of the inflection points with respect to the feed amount becomes.

By utilizing this point, in accordance with a tenth aspect of the present invention, a liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; a controller that, when the liquid is supplied to the supply destination by the supply pump, controls the supply pump such that a pressure detected by the pressure sensor becomes constant at a predetermined pressure; a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount; an acquisition unit acquiring elasticity curve information that includes a range that is not affected by changes over time in the elastic film and ranges that are affected, by acquiring a pressure detected by the pressure sensor at a time when the supply amount per predetermined time of the liquid by the supply pump is changed; a detection unit detecting, as second inflection points, boundary points between the range that is not affected by changes over time in the elastic film and the ranges that are affected, from the elasticity curve information acquired by the acquisition unit; and a specifying unit specifying a state of changes over time in the elastic film, on the basis of a state of offset between the first inflection points and the second inflection points.

When the liquid is supplied to the predetermined supply destination by the supply pump, the supply pump is controlled by the controller such that the pressure detected by the pressure sensor becomes constant at a predetermined pressure.

The memory stores in advance, as first inflection points, boundary points between a range that is not affected by changes over time in the elastic film that demarcates the liquid chamber and the air chamber of the storage tank and ranges that are affected, in an elasticity curve that expresses the relationship between the supply amount per predetermined time of the liquid by the supply pump and the pressure of the liquid chamber at the time when the liquid is supplied at that supply amount. Due to the acquisition unit acquiring the pressure detected by the pressure sensor at the time when the supply amount per predetermined time of the liquid by the supply pump is changed, the acquisition unit acquires elasticity curve information that includes a range that is not affected by changes over time in the elastic film and ranges that are affected. The boundary points, between the range that is not affected by changes over time in the elastic film and the ranges that are affected, are detected by the detection unit as second inflection points from the elasticity curve information acquired by the acquisition unit. The state of changes over time in the elastic film is specified by the specifying unit on the basis of the state of offset between the first inflection points and the second inflection points.

By carrying out feed control that corresponds to the specified state of the changes over time in this way, the feed amount of the liquid can be controlled with high accuracy.

In accordance with an eleventh aspect of the present invention, there is provided an image forming device including a liquid supply device that includes: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; a controller that, when the liquid is supplied to the supply destination by the supply pump, adjusts pressure detected by the pressure sensor by adjustment values that are derived in advance, and controls the supply pump such that an adjusted pressure becomes constant at a predetermined pressure; and a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film, wherein the controller controls the supply pump such that there becomes a supply amount that is substantially the same as a supply amount of the first information, and acquires, as second information, a pressure detected by the pressure sensor at that time, and derives the adjustment values on the basis of an offset amount between pressures of the first information and the second information.

Accordingly, the feed amount of the liquid can be controlled with high accuracy.

In accordance with an twelfth aspect of the present invention, there is provided an image forming device including a liquid supply device that includes: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; a controller that, when the liquid is supplied to the supply destination by the supply pump, controls the supply pump such that a pressure detected by the pressure sensor becomes constant at a predetermined pressure; a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount; an acquisition unit acquiring elasticity curve information that includes a range that is not affected by changes over time in the elastic film and ranges that are affected, by acquiring a pressure detected by the pressure sensor at a time when the supply amount per predetermined time of the liquid by the supply pump is changed; a detection unit detecting, as second inflection points, boundary points between the range that is not affected by changes over time in the elastic film and the ranges that are affected, from the elasticity curve information acquired by the acquisition unit; and a specifying unit specifying a state of changes over time in the elastic film, on the basis of a state of offset between the first inflection points and the second inflection points.

Accordingly, the feed amount of the liquid can be controlled with high accuracy.

In accordance with a thirteenth aspect of the present invention, there is provided a computer readable medium storing a program causing a liquid supply device to execute a process, the liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film, the process including: controlling the supply pump such that there becomes a supply amount that is substantially the same as a supply amount of the first information, and acquiring, as second information, a pressure detected by the pressure sensor at that time; deriving adjustment values in accordance with an offset amount between pressures of the first information and the second information; when the liquid is supplied to the supply destination by the supply pump, adjusting pressure detected by the pressure sensor by the adjustment values; and controlling the supply pump such that a pressure after adjustment becomes constant at a predetermined pressure.

Accordingly, in accordance with the above-described thirteenth aspect, a computer can be made to operate in the same way as the invention relating to the first aspect of the present invention. Therefore, in the same way as the invention relating to the first aspect of the present invention, the feed amount of the liquid can be controlled with high accuracy.

In accordance with a fourteenth aspect of the present invention, there is provided a computer readable medium storing a program causing a liquid supply device to execute a process, the liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount, the process including: acquiring elasticity curve information that includes a range that is not affected by changes over time in the elastic film and ranges that are affected, by acquiring a pressure detected by the pressure sensor at a time when the supply amount per predetermined time of the liquid by the supply pump is changed; detecting, as second inflection points, boundary points between the range that is not affected by changes over time in the elastic film and the ranges that are affected, from the acquired elasticity curve information; and specifying a state of changes over time in the elastic film, on the basis of a state of offset between the first inflection points and the second inflection points.

Accordingly, in accordance with the above-described fourteenth aspect, a computer can be made to operate in the same way as the invention relating to the tenth aspect of the present invention. Therefore, in the same way as the invention relating to the tenth aspect of the present invention, the feed amount of the liquid can be controlled with high accuracy.

In accordance with a fifteenth aspect of the present invention, there is provided a computer readable medium storing a program causing a computer to execute a process, the computer controlling a liquid supply device, the liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film, the process including: controlling the supply pump such that there becomes a supply amount that is substantially the same as a supply amount of the first information, and acquiring, as second information, a pressure detected by the pressure sensor at that time; deriving adjustment values in accordance with an offset amount between pressures of the first information and the second information; when the liquid is supplied to the supply destination by the supply pump, adjusting pressure detected by the pressure sensor by the adjustment values; and controlling the supply pump such that a pressure after adjustment becomes constant at a predetermined pressure.

Accordingly, in accordance with the above-described fifteenth aspect, a computer can be made to operate in the same way as the controller of the liquid supply device relating to the first aspect of the present invention. Therefore, in the same way as in the liquid supply device, the feed amount of the liquid can be controlled with high accuracy.

In accordance with a sixteenth aspect of the present invention, there is provided a computer readable medium storing a program causing a computer to execute a process, the computer controlling a liquid supply device, the liquid supply device including: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount, the process including: acquiring elasticity curve information that includes a range that is not affected by changes over time in the elastic film and ranges that are affected, by acquiring a pressure detected by the pressure sensor at a time when the supply amount per predetermined time of the liquid by the supply pump is changed; detecting, as second inflection points, boundary points between the range that is not affected by changes over time in the elastic film and the ranges that are affected, from the acquired elasticity curve information; and specifying a state of changes over time in the elastic film, on the basis of a state of offset between the first inflection points and the second inflection points.

Accordingly, in accordance with the above-described sixteenth aspect, a computer can be made to operate in the same way as the controller, the acquisition unit, the detection unit and the specifying unit of the liquid supply device relating to the tenth aspect of the present invention. Therefore, in the same way as in the liquid supply device, the feed amount of the liquid can be controlled with high accuracy.

An exemplary embodiment of the present invention will be described in detail hereinafter with reference to the drawings. Note that a case will be described herein in which the present invention is applied to an inkjet printer (hereinafter called “inkjet recording device”) that forms an image by ink drops.

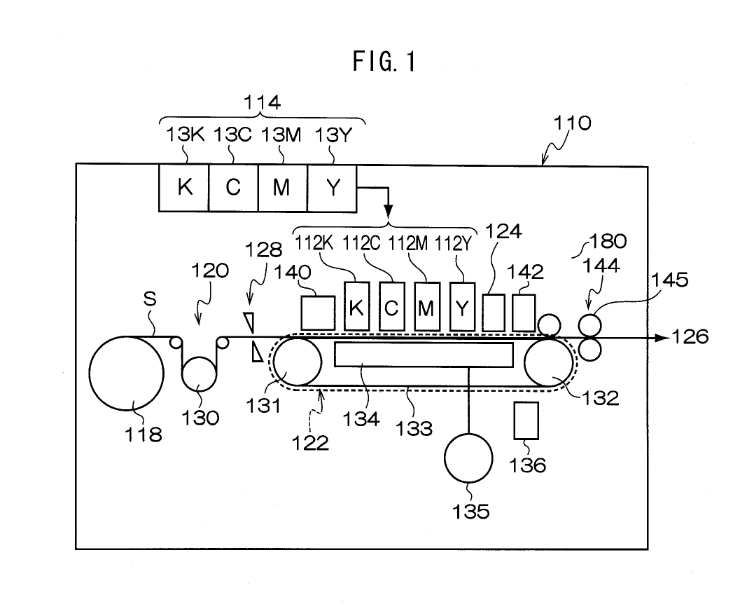

FIG. 1 is a general block diagram of an ink-jet recording apparatus and showing the exemplary embodiment of an image forming apparatus according to the invention.

### (Ink-Jet Recording Apparatus)

As shown in the drawing, the ink-jet recording apparatus 110 includes a printing portion 112 having a plurality of ink-jet recording heads (hereafter referred to as heads) 112K, 112C, 112M, and 112Y provided to correspond to respective inks of black (K), cyan (C), magenta (M), and yellow (Y), an ink storage/loading portion 114 for storing ink to be supplied to the respective heads 112K, 112C, 112M, and 112Y, a paper feeding portion 118 for feeding recording paper 116 as a recording medium, a curl removing portion 120 for removing curl of the recording paper 116, a belt conveying portion 122 disposed to face a nozzle face (ink jet face) of the printing portion 112 to convey the recording paper 116 while maintaining flatness of the recording paper 116, a printing detecting portion 124 for reading a result of printing by the printing portion 112, and a paper ejecting portion 126 for ejecting recording paper (printed matter) outside after recording. In the present specification, “printing” includes printing of image as well as printing of letters.

The ink storage/loading portion 114 has ink tanks for storing ink of colors corresponding to the respective heads 112K, 112C, 112M, and 112Y and the respective tanks 13K, 13C, 13M and 13Y communicate with the heads 112K, 112C, 112M, and 112Y through ducts. The ink storage/loading portion 114 further includes an informing component for informing that an ink level is low if this is the case and a mechanism for preventing loading of tanks of wrong colors.

Although a magazine for roll paper (continuous paper) is shown as an example of the paper feeding portion 118 in FIG. 1, a plurality of magazines for different paper widths and paper qualities may be provided. Instead of or in addition to the magazine for the roll paper, a cassette in which a stack of cut sheets is loaded may be used to feed paper.

If a plurality of kinds of recording media may be used, bar-codes or information recording bodies such as wireless tags on which pieces of kind information of the media are recorded are attached to the magazines, a predetermined reading device reads the information on the information recording body to thereby automatically identify the kind (media kind) of the recording medium to be used, and ink jet control is carried out to achieve ink jet suitable to the media kind, preferably.

The recording paper S sent out from the paper feeding portion 118 retains curl and curls, because it was loaded in the magazine. To remove the curl, in the curl removing portion 120, a heating drum 130 gives heat to the recording paper S in an opposite direction to a direction of the curl in the magazine. At this time, it is preferable to control heating temperature so that a print side is slightly curled outward.

In a case of an apparatus structure in which the roll paper is used, a cutter 128 for cutting is provided as shown in FIG. 1 and the cutter 128 cuts the roll paper to desired lengths. If the cut sheets are used, the cutter 128 is unnecessary.

After the curl removal treatment, the recording paper S is cut and sent to the belt conveying portion 122. In the belt conveying portion 122, an endless belt 133 is looped over rollers 131, 132.

The belt 133 is wider than the recording paper S and is formed on its belt face with a large number of suction holes. As shown in the drawing, an attracting chamber 134 is provided in such a position inside the belt 133 looped over the rollers 131, 132 as to face the nozzle face of the printing portion 112 and a sensor face of the printing detecting portion 124. By sucking the attracting chamber 134 with a fan 135 to form a negative pressure in the chamber 134, the recording paper S is attracted and retained onto the belt 133. Electrostatic attraction may replace the suction attraction.

When power of a motor is transmitted to at least one of the rollers 131, 132 over which the belt 133 is looped, the belt 133 is driven clockwise in FIG. 1 and the recording paper S retained on the belt 133 is conveyed from left to right in FIG. 1.

Because the ink adheres onto the belt 133 after borderless printing or the like, there is a belt cleaning portion 136 provided in a predetermined position outside the belt 133 (a suitable position outside a printing area). The belt cleaning portion 136 may employ a method of nipping with a brush roll, a water absorption roll, and the like, an air blowing method of blowing clean air, or a combination of them, for example. In the case of the method of nipping with the cleaning roll, great cleaning effect may be obtained by setting belt linear speed and roller linear speed different from each other.

A roller nip conveying mechanism may be employed in place of the belt conveying portion 122. If the printing area is conveyed by roller nipping, however, the image is likely to be blurred, because the roller comes in contact with the print side of paper immediately after printing. Therefore, in the printing area, the attracting belt conveyance without contact with the image surface is preferable.

On an upstream side of the printing portion 112 on a paper conveying path formed of the belt conveying portion 122, a heating fan 140 is provided. The heating fan 140 blows heated air on the recording paper S before printing to heat the recording paper S. If the recording paper S is heated immediately before printing, ink dries faster after landing.

Each of the heads 112K, 112C, 112M, and 112Y of the printing portion 112 has a length corresponding to a maximum sheet width of the recording paper S intended for use in the ink-jet recording apparatus 110 and is a full-line head with a nozzle face on which a plurality of nozzles for jetting ink are arranged throughout a length (an entire width of a printable area) more than at least one side of the largest-sized recording paper S.

The heads 112K (black) (K), 112C (cyan) (C), 112M (magenta) (M), and 112Y (yellow) (Y) are disposed in this order from the upstream side along a feeding direction of the recording paper S. The respective heads 112K, 112C, 112M, and 112Y are fixed to extend along a direction substantially orthogonal to the conveying direction of the recording paper 116.

By conveying the recording paper S with the belt conveying portion 122 while discharging inks of different colors from the respective heads 112K, 112C, 112M, and 112Y, a color image may be formed on the recording paper 116.

As described above, with the structure provided with the full-line heads 112K, 112C, 112M, and 112Y of different colors and having nozzle rows covering the entire sheet width, a full-page image may be recorded on the recording paper S with a single operation (i.e., with single sub-scanning) of moving the recording paper S and the printing portion 112 with respect to each other in the paper feeding direction (sub-scanning direction). Therefore, printing at higher speed is possible and productivity may be improved as compared with shuttle-type heads in which recording heads reciprocate in a direction orthogonal to a sheet conveying direction.

Although standard colors (four colors), K, C, M, and Y have been described as examples in the exemplary embodiment, a combination of colors of inks and the number of colors is not limited to that in the exemplary embodiment. Light-colored inks, deep-colored inks, inks of custom colors may be added as necessary. For example, ink-jet heads for jetting light-colored ink such as light cyan and light magenta may be added. The order of arrangement of the heads of the respective colors is not especially limited either.

The printing detecting portion 124 shown in FIG. 1 includes an image sensor (a line sensor or an area sensor) for picking up an image of a result of jet by the printing portion 112 and functions as a means of checking jet characteristics such as clogging in the nozzles and landing position errors based on the image of jet read by the image sensor.

Preferably, used as the printing detecting portion 124 in the exemplary embodiment may be a CCD area sensor formed of a two-dimensional array of a plurality of light receiving elements (photoelectric conversion elements) on a light receiving surface. The area sensor has an imaging range covering at least the entire ink discharge width (image recording width) by the respective heads 112K, 112C, 112M, and 112Y. A single area sensor may cover a necessary imaging range or a plurality of area sensors may be combined (pieced together) to cover the necessary imaging range. Alternatively, the area sensor may be supported on a moving mechanism and moved (caused to scan) to take an image of the required imaging range.

A line sensor may be used in place of the area sensor. In this case, the line sensor preferably includes an array of light receiving elements (an array of photoelectric conversion elements) wider than at least the ink jet width (image recording width) by the respective heads 112K, 112C, 112M, and 112Y.

As described above, the printing detecting portion 124 is a block including the image sensor, reads the image printed on the recording paper S, performs necessary signal processing and the like to detect printing conditions (whether or not discharge was carried out, landing position errors, dot shapes, optical density, and the like), and provides the detection result to a print control unit and a system controller (not shown).

A posterior drying portion 142 is provided in a subsequent stage to the printing detecting portion 124. The posterior drying portion 142 is a means for drying the printed image surface and a heating fan is used for the portion 142, for example. Since it is preferable to avoid contact with the printed surface until the ink dries after printing, blowing heated air is preferable.

In a case of printing on porous paper with dye-based ink, weather resistance of the image may be improved by closing holes in the paper by pressurization to thereby avoid contact with substances such as ozone responsible for breakdown of dye molecules.

A heating/pressure-applying section 144 is provided at the stage after the posterior drying portion 142. The heating/pressure-applying section 144 is a means for controlling the degree of gloss of the image surface. While heating the image surface, the heating/pressure-applying section 144 applies pressure to the image surface by a pressure-applying roller 145 whose surface has a predetermined indented and protruded shape, such that the indentations and protrusions are transferred to the image surface. The printed matter that is generated in this way is discharged-out from a sheet discharging section 126. Note that, although not shown, a sorter that stacks images per order is provided at the sheet discharging section 126 of the present image.

### (Internal Structure of Ink Supply System)

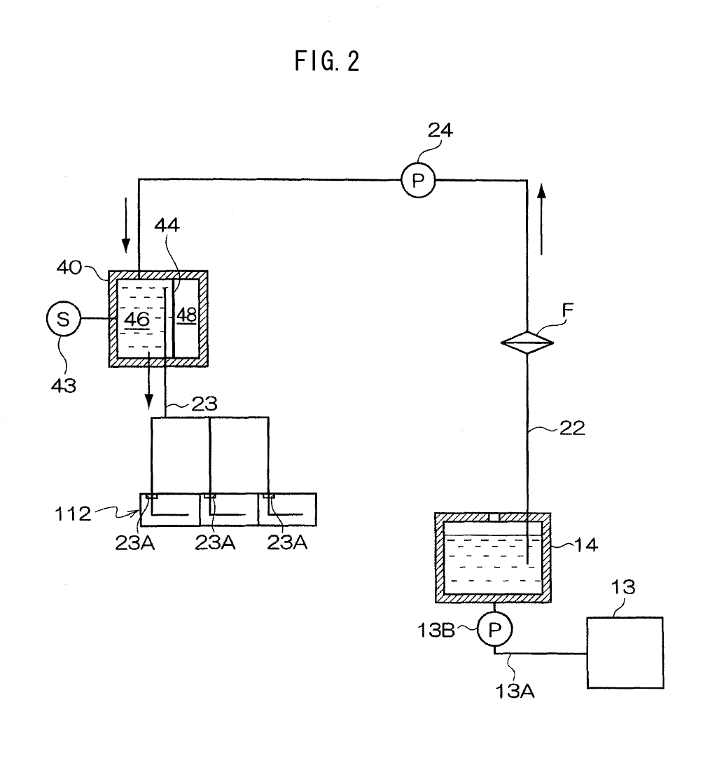

FIG. 2 illustrates, in a simplified manner, the internal structure of the ink supply system at the inkjet recording device 110. Because the respective heads 112K, 112C, 112M, 112Y and the ink tanks 13K, 13C, 13M, 13Y that store inks of the corresponding colors have similar structures, here, only one will be described as the head 112 and the ink tank 13.

The ink tank 13 is connected to a buffer tank 14 via a pipe 13A. The buffer tank 14 is open to the atmosphere. A pump 13B is provided at the pipe 13A. By driving the pump 13B, the ink that is stored in the ink tank 13 is supplied to the buffer tank 14. Due to the ink supply from the ink tank 13, a predetermined amount of the ink is stored in the buffer tank 14.

The buffer tank 14 and the head 112 are connected via a supply damper 40 and a flow path 22. A supply pump 24, that carries out feeding between the supply damper 40 and the buffer tank 14, is provided on the flow path 22. A filter F is provided on the flow path 22 between the supply pump 24 and the buffer tank 14. The supply damper 40 communicates with the head 112 via a supply path 23.

In the present exemplary embodiment, the supply pump 24 must continuously supply ink at a uniform flow rate, and a metering pump is used therefor from the standpoints of precision and reliability. The amount that is fed-out by one rotation of the supply pump 24 is fixed (e.g., 5 mL/rotation).

A pump that can feed-out ink in both directions is used as the supply pump 24. In the present exemplary embodiment, the direction of feeding ink from the supply pump 24 toward the supply damper 40 is called the “forward direction”, and, on the other hand, the direction of feeding ink from the supply pump 24 toward the buffer tank 14 is called the “reverse direction”.

The interior of the supply damper 40 is demarcated into a liquid chamber 46 and an air chamber 48 by an elastic film 44. Ink is stored in the liquid chamber 46, and the flow path 22 and the supply path 23 communicate with the liquid chamber 46 of the supply damper 40.

The elastic film 44 is formed of an elastically deformable material, and is preferably structured by rubber, a thermoplastic elastomer, or the like. In particular, fluororubbers and NBR can be suitably used. A pressure sensor 43 is connected to the supply damper 40. The pressure sensor 43 can detect the pressure within the liquid chamber 46. Air is filled in the air chamber 48.

The head 112 is divided into plural (three in FIG. 2) head bars, and a supply port 23A for supplying ink is formed at each of the head bars. The supply path 23 is branched-off before the supply ports 23A such that ink is supplied to the respective head bars from the respective supply ports 23A. Although not illustrated, each head bar has plural nozzles, and ink is ejected from the respective nozzles.

The present exemplary embodiment describes an example in which the recording head is divided into plural head bars, but the recording head may be a single unit and not be divided.

In this way, a supply system flow path is structured by the buffer tank 14, the flow path 22, the supply damper 40 and the supply path 23.

### (System Structure)

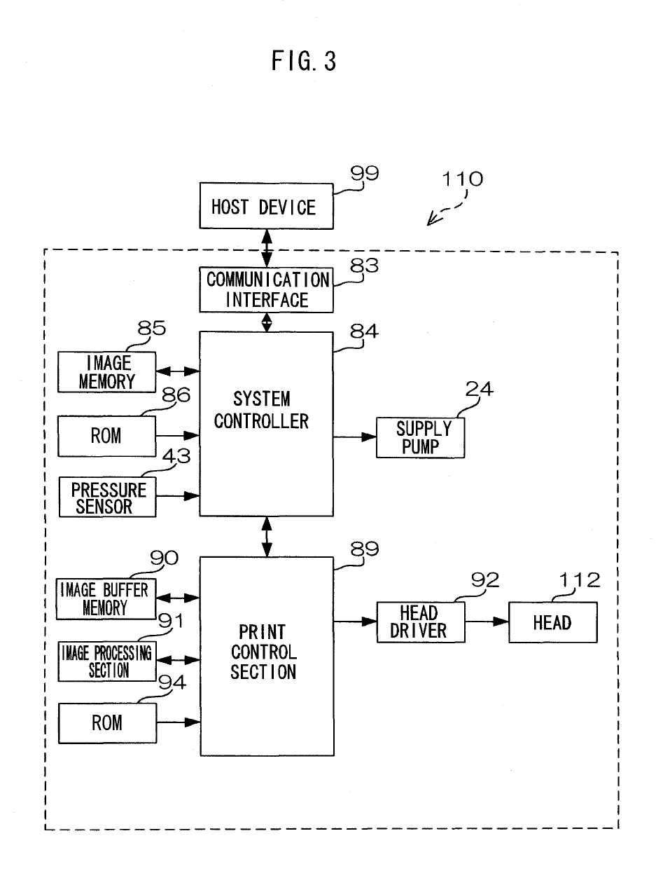

The system structure of the inkjet recording device 100 relating to the present exemplary embodiment will be described with reference to FIG. 3.

The inkjet recording device 110 has a communication interface 83, a system controller 84, an image memory 85, a ROM 86, a print control section 89, an image buffer memory 90, an image processing section 91, a head driver 92, and the like.

The communication interface 83 is an interface portion with a host device 99 used by a user to give instructions for printing to the ink-jet recording apparatus 110. As the communication interface 83, a serial interface such as USB (Universal Serial Bus), IEEE1394, Ethernet, and wireless network or a parallel interface such as Centronics. This part may be mounted with buffer memory for speeding up the communication.

Image information sent-out from the host device 99 is taken-in into the inkjet recording device 110 via the communication interface 83, and is once stored in the image memory 85. The image memory 85 stores the image information that is inputted via the communication interface 83, and reading and writing of information from and to the image memory 85 are carried out through the system controller 84. The image memory 85 is not limited to a memory that is formed from a semiconductor element, and a magnetic medium such as a hard disk or the like may be used.

The system controller 84 is structured from a central processing unit (CPU), peripheral circuits thereof, and the like. The system controller 84 functions as a control device that controls the entire inkjet recording device 110 in accordance with predetermined programs, and also functions as a computing device that carries out various types of computation. Namely, the system controller 84 carries out control of the communication interface 83 and the image memory 85 as well as respective portions such as the above-described pressure sensor 43, supply pump 24 and the like, and control of communications with the host device 99, and control of the reading from and writing to the image memory 85 and the ROM 86, and control of the supplying of ink using the supply pump 24 and the pressure sensor 43, and the like. Note that the system controller 84 transmits, in addition to control signals, the image information stored in the image memory 85 to the print control section 89.

Programs executed by the CPU of the system controller 84, various types of data needed for control, and the like are stored in the ROM 86. The ROM 86 may be a non-rewritable memory. However, in cases in which various types of data are updated as needed, it is preferable to use a rewritable memory such as an EEPROM as the ROM 86.

The image memory 85 is used as a temporary storage region for image information, and is used as a region for expansion of programs and as a region for the computing work of the CPU.

The pressure sensor 43 is connected to the liquid chamber 46 (see FIG. 2), and converts the pressure of the liquid chamber 46 into a voltage value and outputs it to the system controller 84. At the system controller 84, the acquired voltage value is converted into a pressure value. In the present exemplary embodiment, in order to control the amount of ink within the liquid chamber 46 such that the pressure of the liquid chamber 46 becomes a predetermined value, the system controller 84 outputs commands to the supply pump 24 to feed-out ink, on the basis of the acquired pressure value of the liquid chamber 46.

The print control section 89 is structured by a CPU, peripheral circuits thereof, and the like. In accordance with the control of the system controller 84, the print control section 89 carries out, in cooperation with the image processing section 91, processings such as various types of manipulation, correction and the like in order to generate signals for ejection control from the image information within the image memory 85. The print control section 89 also supplies the generated ink ejection data to the head driver 92, and controls the ejection driving of the head 112.

A ROM 94, that stores programs that are executed by the CPU of the print control section 89, various types of data needed for control, and the like, is connected to the print control section 89. The ROM 94 also may be a non-rewritable memory. However, in cases in which various types of data are updated as needed, it is preferable to use a rewritable memory such as an EEPROM as the ROM 94.

The image processing section 91 generates, from the inputted image information, dot placement data for each of the ink colors, and carries out halftoning processing on the inputted image information and determines dot positions of high quality.

In cases in which density conversion processing (including UCR processing or color conversion) is needed, the image processing section 91 relating to the present exemplary embodiment carries out pixel number converting processing, density correcting processing, halftoning processing (intermediate gradation processing) that converts from multi-value density data into binary (or multi-value) dot placement data, and the like.

FIG. 3 shows the image processing section 91 as being separate from the system controller 84 and the print control section 89. However, for example, the image processing section 91 may be included in the system controller 84 or the print control section 89 and structure a portion thereof.

The print control section 89 has an ink ejection data generating function that generates ejection data of the ink (control signals for the actuators corresponding to the nozzles of the head 112) on the basis of the dot placement data generated at the image processing section 91, and a driving waveform generating function.

The ink ejection data generated by the ink ejection data generating function is provided to the head driver 92, and the ink ejecting operation of the head 112 is controlled.

The driving waveform generating function is a function that generates driving signal waveforms for driving the actuators corresponding to the respective nozzles of the head 112. The signals that are generated by the driving waveform generating function (driving signals) are supplied to the head driver 92. The signals generated by the driving waveform generating function may be digital waveform data, or may be analog electric signals.

The image buffer memory 90 is provided at the print control section 89. At times of processing image information at the print control section 89, image information and data such as parameters and the like are temporarily stored in the image buffer memory 90. FIG. 3 illustrates a state in which the image buffer memory 90 is annexed to the print control section 89, but the image buffer memory 90 may also serve as the image memory 85.

Programs relating to print control are stored in advance in the ROM 94. Note that the print control section 89 and the system controller 84 may be combined and made to structure a single processor.

In the inkjet recording device 110 relating to the present exemplary embodiment, information expressing the elasticity curve shown in FIG. 10A as an example is acquired by using the actual inkjet recording device 110 at a predetermined timing (hereinafter, this information is called “initial elasticity curve information”), and is stored in advance in a predetermined region of the ROM 86. The predetermined timing is preferably a time at which changes over time in the pressure sensor 43 have not progressed. In the inkjet recording device 110 relating to the present exemplary embodiment, the predetermined timing is the time of shipping-out from the manufacturing factory that manufactures the inkjet recording device 110, but is not limited to the same.

Operation of the inkjet recording device 110 relating to the present exemplary embodiment will be described.

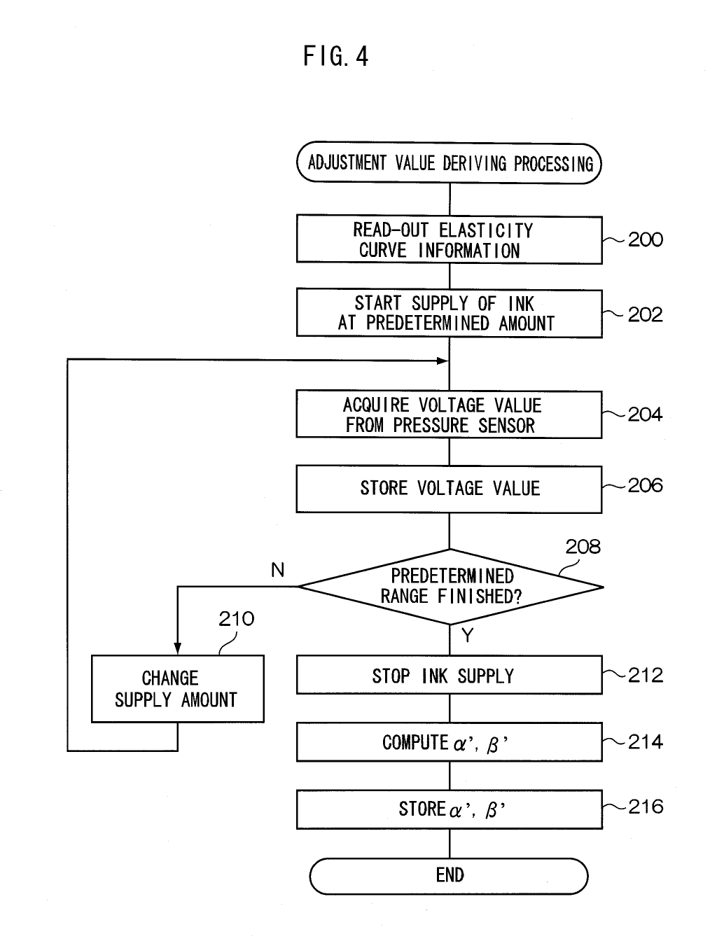

The inkjet recording device 110 relating to the present exemplary embodiment executes, at a predetermined timing, adjustment value deriving processing that derives adjustment values for adjusting the pressure value obtained from the pressure sensor 43. First, operation of the inkjet recording device 110 at the time of executing this adjustment value deriving processing will be described with reference to FIG. 4. FIG. 4 is a flowchart showing the flow of the processing of an adjustment value deriving processing program that is executed by the system controller 84 of the inkjet recording device 110 at this time. This program is stored in advance in a predetermined region of the ROM 86.

In step 200, the aforementioned initial elasticity curve information is read-out from the ROM 86. In step 202, control of the supply pump 24 is started so that the supply amount of ink per predetermined time (in the present exemplary embodiment, per one second) (hereinafter simply called “supply amount”) becomes a predetermined, initially set amount. In the adjustment value deriving processing program relating to the present exemplary embodiment, the minimum value of the feed amounts in the elasticity curve information read-out by the processing of step 200 is used as the initially set amount. For example, in a case in which the initial elasticity curve information is the information shown in FIG. 10A, −60 (mL/sec) is used as the initially set amount. Therefore, the ink feed-out direction of the supply pump 24 is made to be the reverse direction, and the supply amount is set at the supply pump 24 to be 60 (mL/sec).

In step 204, the voltage value is acquired from the pressure sensor 43. In next step 206, the acquired voltage value is stored in a predetermined region of the image memory 85.

In step 208, it is judged whether or not the measurement of the voltage value by step 204 and step 206 is finished for all values within a predetermined range. If this judgment is negative, the routine moves on to step 210 where the supply pump 24 is controlled so that the supply amount of the ink is increased by a predetermined amount (in the present exemplary embodiment, 5 (mL/sec)), and thereafter, the routine returns to step 204. At the point in time when the judgment becomes affirmative, the routine moves on to step 212. In the adjustment value deriving program relating to the present exemplary embodiment, a range up to the maximum amount of the feed amounts in the elasticity curve information read-out by the processing of above-described step 200 is used as the aforementioned predetermined range.

When the processings of step 204 through step 210 are executed repeatedly, at the time when the supply amount of the ink changes from a negative amount to a positive amount, the supply pump 24 is set such that the ink feed-out direction thereof becomes the forward direction. Due thereto, in a case in which the initial elasticity curve information is the information shown in FIG. 10A, information (hereinafter called “measured voltage information”) expressing the voltage values by the pressure sensor 43 in the range from a negative amount to a positive amount of the feed amount, can be acquired by repeating the processings of above step 204 through step 210.

In step 212, the supply pump 24 is controlled so as to stop the supplying of ink that was started by the processing of step 202, and the routine moves on to step 214.

In step 214, adjustment values α′ and β′ are computed by substituting, into formula (6) and formula (7), pressure values p₁ and p₂ of the initial elasticity curve information read-out by the processing of step 200 and voltage values V₁′ and V₂′ in the measured voltage information, that correspond to two predetermined points within the slack region of the elastic film 44 (the region that is not affected by changes over time in the elastic film 44: the substantially rectilinear region in FIG. 10A as an example).

In step 216, the adjustment values α′ and β′ computed by the processing of step 214 are stored in a predetermined region of the image memory 85, and thereafter, the present adjustment value deriving processing program ends.

Examples of the timing at which the present adjustment value deriving processing program is executed are each predetermined time period such as each month, or each half-year or the like, or at the time when the power source is turned on, or at times when there is an abnormality such as a paper jam or the like, or at an arbitrary time such as when one print job ends or the like. In the inkjet recording device 110 relating to the present exemplary embodiment, a timing that is each predetermined time period is used.

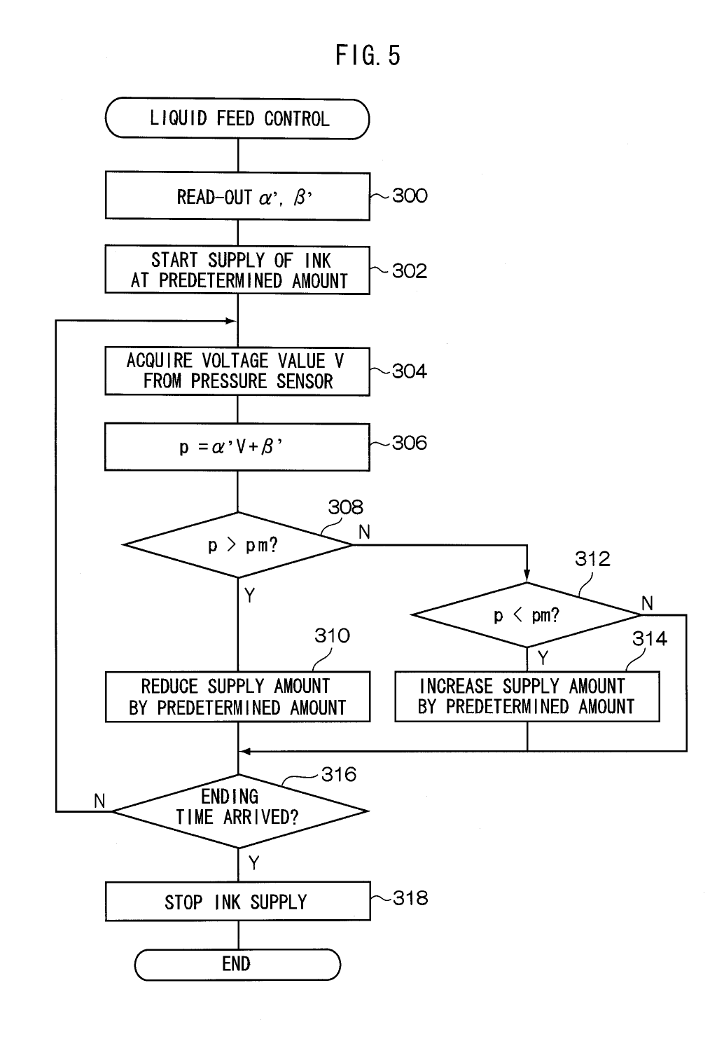

Operation of the inkjet recording device 110 at the time of forming an image will be described with reference to FIG. 5. FIG. 5 is a flowchart showing the flow of the processing of a liquid feed control program that is executed by the system controller 84 of the inkjet recording device 110 at this time. This program as well is stored in advance in a predetermined region of the ROM 86.

In step 300 of FIG. 5, the adjustment values α′ and β′, that are stored by the adjustment value deriving processing program being executed, are read-out from the image memory 85. In step 302, control of the supply pump 24 is started so that the ink supply amount becomes a predetermined, initially set amount.

In step 304, the voltage value V is acquired from the pressure sensor 43. In step 306, by substituting the adjustment values α′ and β′ that were read-out in step 300 and the voltage value V that was acquired by the processing of step 304, into the following calculation formula, the voltage value V is converted into the pressure value p.

p=α′V+β′

In step 308, it is judged whether or not the computed pressure value p is greater than a target pressure value pm that is determined in advance. If the judgment is affirmative, the routine moves on to step 310.

In step 310, the supply pump 24 is controlled such that the supply amount of the ink at that point in time is reduced by a predetermined amount (in the present exemplary embodiment, 1 mL/sec). Thereafter, the routine moves on to step 316.

If the judgment in step 308 is negative, the routine moves on to step 312 where it is judged whether or not the pressure value p is smaller than the target pressure value pm. If the judgment is affirmative, the routine moves on to step 314 where the supply pump 24 is controlled such that the ink supply amount at that point in time is increased by a predetermined amount (in the present exemplary embodiment, 1 mL/sec), and thereafter, the routine moves on to step 316. If the judgment in step 312 is negative, there is a case in which the pressure value p is equal to the target pressure value pm, and therefore, the routine moves on to step 316 without increasing or decreasing the supply amount.

In step 316, it is judged whether or not a predetermined ending time has arrived. If the judgment is negative, the routine returns to step 304. At the point in time when the judgment becomes affirmative, the routine moves on to step 318. Examples of the ending time are a time when a situation arises in which the image formation processing must be stopped such as a paper jam or the like, or the time when printing of one print job is completed, or a time when forced ending is instructed by the user, or the time when the power source of the inkjet recording device 110 is turned off, or the like. In step 318, the supply pump 24 is controlled so as to stop the supplying of ink that was started by the processing of step 302, and thereafter, the present liquid feed control program ends.

In the elasticity curve of the supply damper 40, due to the elastic film 44 that is provided at the supply damper 40 changing over time, the positions of the inflection points of the region that is not affected by changes over time in the elastic film 44 (the slack region) and the regions that are affected become offset. More specifically, the softer the elastic film 44 becomes, the more the interval of the inflection points with respect to the feed amount widens.

By utilizing the above-described point, the inkjet recording device 110 relating to the present exemplary embodiment is equipped with an elastic film state detecting function that specifies and gives notice of the state of the elastic film 44. Therefore, the boundary points between the range that is not affected by changes over time in the elastic film 44 (the range of the slack region) and the ranges that are affected in the above-described initial elasticity curve information are made to be the inflection points, and inflection point information that expresses the inflection points is stored in advance in a predetermined region of the ROM 86. A time when changes over time in the elastic film 44 have not advanced is preferably used as the time for acquiring and storing the inflection point information. In the inkjet recording device 110 relating to the present exemplary embodiment, this time is the aforementioned time of shipment from the manufacturing factory, but is not limited to the same.

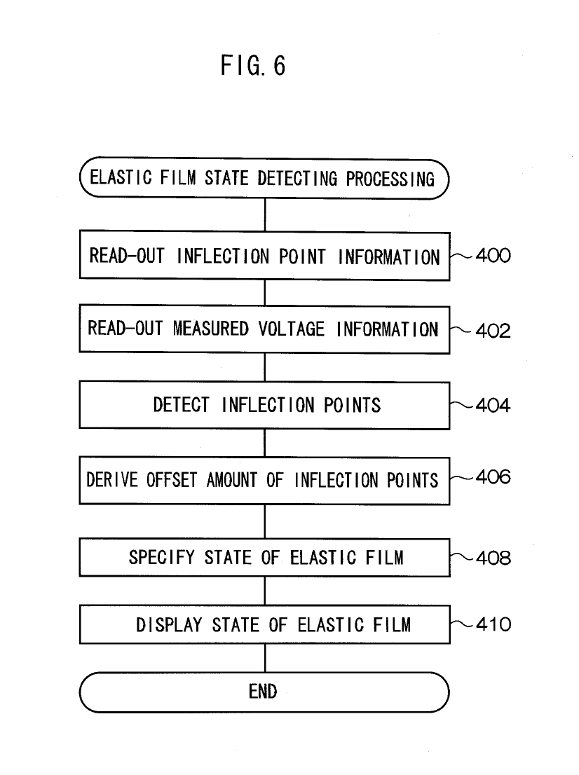

Operation of the inkjet recording device 110 at the time when the elastic film state detecting function works will be described with reference to FIG. 6. FIG. 6 is a flowchart showing the flow of processing of an elastic film state detecting processing program that is executed by the system controller 84 of the inkjet recording device 110 at the time when implementation of this elastic film state detecting function is instructed. This program as well is stored in advance in a predetermined region of the ROM 86.

In step 400, the aforementioned inflection point information is read-out from the ROM 86. In next step 402, the measured voltage information, that was stored by execution of the above-described adjustment value deriving processing program, is read-out from the image memory 85.

In step 404, the boundary points between a range that is not affected by changes over time in the elastic film 44 (the range of the slack region) and ranges that are affected are detected as second inflection points from the read-out measured voltage information. The following four types of methods are examples of the method of detecting the second inflection points.

1. A region, that includes a region where the feed amount of the liquid is 0 (zero) and at which the differences in adjacent rates of change in pressure per predetermined feed amount are constant within a range of errors, is detected as a slack region, and the both end points of this slack region are specified as inflection points.

2. A region, that includes a region where the pressure of the liquid chamber is 0 (zero) and at which the differences in adjacent rates of change in feed amount per predetermined pressure are constant within a range of errors, is detected as a slack region, and the both end points of this slack region are specified as inflection points.

3. The boundary points between a region, where the differences in adjacent rates of change in pressure per predetermined feed amount are greater than or equal to a predetermined value, and regions where the differences are less than the predetermined value, are detected as inflection points.

4. The boundary points between a region, where the differences in adjacent rates of change in feed amount per predetermined pressure are greater than or equal to a predetermined value, and regions where the differences are less than the predetermined value, are detected as inflection points.

The above-described four types of methods are examples, and other inflection point detecting methods can be used.

The inflection point information that is stored in advance in the ROM 86 can also be stored by outputting (displaying or printing) the elasticity curve information as a graph such as shown in FIG. 10A for example, and specifying the inflection points visually by referring to this graph. It is more preferable to apply a method that detects the inflection points automatically, including the above-described four types of methods, because convenience can be improved as a result of being able to suppress manual intervention.

In step 406, the state of offset between the inflection points, that are shown by the inflection point information read-out by the processing of step 400, and the inflection points, that are detected by the processing of step 404, is derived. In the elastic film state detecting processing program relating to the present exemplary embodiment, as the state of the offset, it derived whether or not the interval, with respect to the feed amount, of the inflection points detected by the processing of step 404 (the interval D shown in FIG. 10A as an example) has become longer than the interval, with respect to the feed amount, of the inflection points shown by the inflection point information. However, the detecting of the state of the offset is not limited to the same. A form can be used in which it is derived whether or not the interval, with respect to the pressure value expressed by the aforementioned voltage value V, of the inflection points detected by the processing of step 404 has become shorter than the interval, with respect to the pressure value, of the inflection points shown by the inflection point information.

In step 408, the state of the changes over time in the elastic film 44 is specified on the basis of the state of the offset derived by the processing of step 406. In step 410, information expressing the specified state of the changes over time in the elastic film 44 is displayed by an unillustrated display section, and thereafter, the present elastic film state detecting processing program ends.

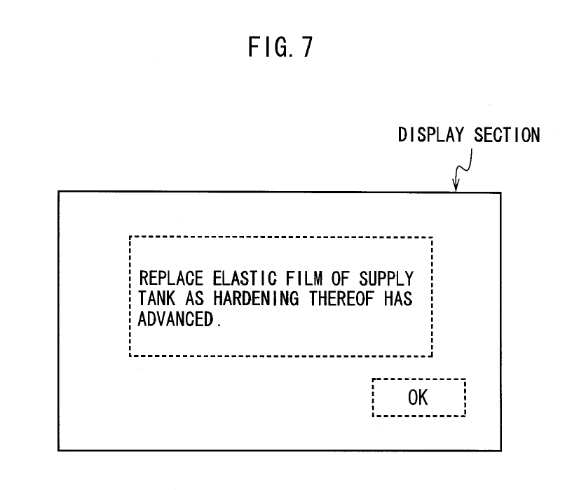

An example of the information that is displayed on the display section by the processing of step 410 of the present elastic film state detecting processing program is shown in FIG. 7. The information that “Replace elastic film of supply tank as hardening thereof has advanced.” is displayed by the display section. Accordingly, by referring to this information, the user who is instructing implementation of the elastic film state detecting function can easily know of the state of the elastic film 44.

In this way, in the elastic film state detecting processing program relating to the present exemplary embodiment, the state of the changes over time in the elastic film 44 is specified by utilizing the measured voltage information obtained by execution of the adjustment value deriving processing program. Therefore, it is preferable to obtain the latest measured voltage information by causing the adjustment value deriving processing program to be executed immediately before implementation of the elastic film state detecting function.

The present invention has been described above by using an exemplary embodiment, but the technical scope of the present invention is not limited to the scope recited in the above-described exemplary embodiment. Various changes and improvements can be made to the above-described exemplary embodiment within a range that does not deviate from the gist of the present invention. Such modified and improved forms as well as included within the technical scope of the present invention.

The above-described exemplary embodiment does not limit the inventions relating to the claims, and all of the combinations of the features described in the exemplary embodiment are not essential to the means of the present invention for solving the problems. Inventions of various stages are included in the above-described exemplary embodiment, and various inventions can be extracted by appropriate combinations of the plural, disclosed structural conditions. Even if several of the structural conditions are eliminated from all of the structural conditions shown in the exemplary embodiment, the structure from which the several structural conditions have been eliminated can be extracted as the invention provided that the effects can be obtained.

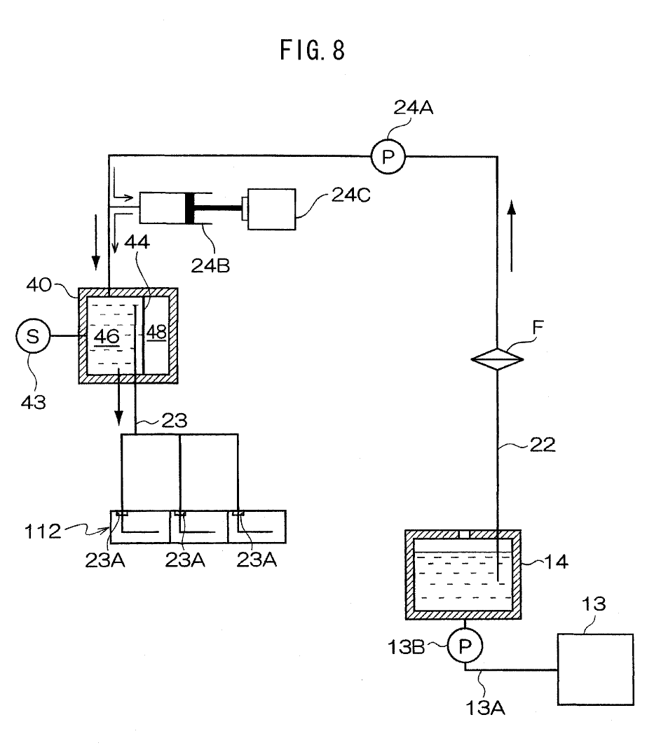

For example, the above exemplary embodiment describes a case in which a metering pump is used as the supply pump of the present invention, but the present invention is not limited to the same. For example, as shown in FIG. 8, a supply pump 24A that is not a metering pump may be used instead of a metering pump, and the supply amount of ink may be controlled to be a fixed amount by using a metering syringe 24B and a linear actuator 24C.

A movable shaft of the linear actuator 24C is connected to a piston portion of the metering syringe 24B. The linear actuator 24C is electrically connected to the system controller 84. The metering syringe 24B is disposed on the flow path that connects the supply pump 24A and the supply damper 40.

At the time of feeding the liquid by the supply pump 24A, the linear actuator 24C is controlled by the system controller 84 such that the feed amount within the flow path from the supply pump 24A to the supply damper 40 becomes the desired amount.

Because the metering syringe 24B and the linear actuator 24C are further provided between the supply pump 24A and the supply damper 40, the feed amount of the liquid can be controlled with even higher accuracy.

Further, because the need to use an expensive metering pump is eliminated, costs can be reduced.

It is good to provide an unillustrated valve at the metering syringe 24B such that, when the metering syringe 24B is not in use, ink does not flow therein.

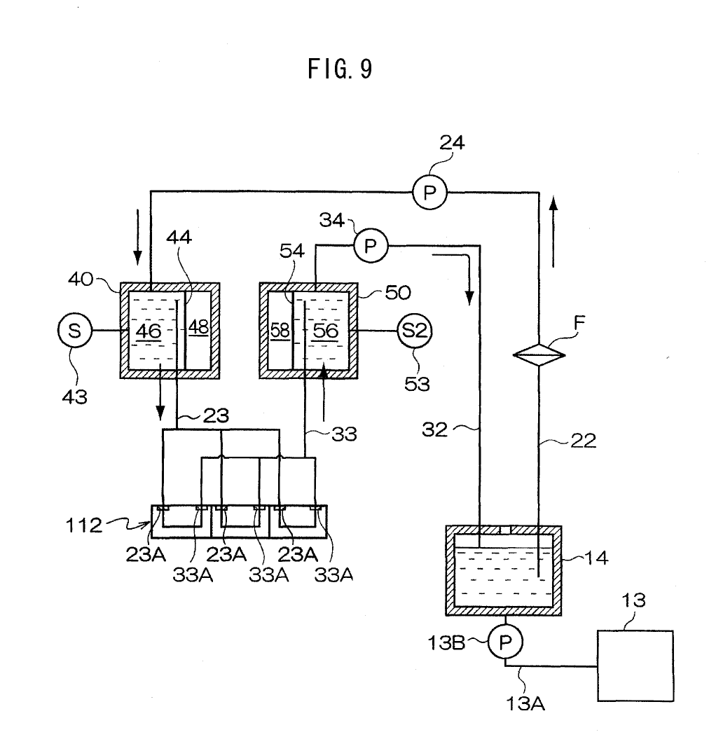

The above exemplary embodiment describes a case in which the present invention is applied to an ink supply system that supplies ink from the buffer tank 14 to the head 112 via the supply damper 40, but the present invention is not limited to the same. For example, as shown in FIG. 9, the present invention may be applied to an ink recovery system that recovers ink except for the ink that is consumed by the head 112.

The buffer tank 14 is connected to a recovery damper 50 via a second flow path 32. A recovery pump 34, that is a metering pump that feeds liquid between the recovery damper 50 and the buffer tank 14, is provided at the second flow path 32. The recovery damper 50 communicates with the head 112 via a recovery path 33. The interior of the recovery damper 50 is demarcated, by a second elastic film 54, into a second liquid chamber 56 and a second air chamber 58. The second flow path 32 and the recovery path 33 communicate with the second liquid chamber 56 of the recovery damper 50. Ink is stored in the second liquid chamber 56, and a second pressure sensor 53 is connected to the recovery damper 50. The second pressure sensor 53 can detect the pressure within the second liquid chamber 56. Discharging ports 33A for discharging ink are formed in the head 112 in correspondence with the supply ports 23A. The respective recovery paths 33 from the respective discharging ports 33A merge in front of the recovery damper 50. Due thereto, ink is supplied from the supply ports 23A, and the ink except for that consumed by the head 112 is recovered from the respective discharging ports 33A and is stored in the second liquid chamber 56 via the recovery paths 33 due to the recovery pump 34.

In the same way as for the above-described supply damper 40, initial elasticity curve information is acquired in advance for the recovery damper 50. Adjustment values (hereinafter called “second adjustment values”) are derived from this initial elasticity curve information and measured voltage information that is obtained by carrying out, for the recovery damper 50, processing that is similar to that of the above-described adjustment value deriving processing program. The output value of the second pressure sensor 53 is adjusted by processing that is similar to that of the above-described liquid feed control program. Here, the ink can be circulated smoothly by setting the target pressure value of the recovery damper 50 to be lower than the target pressure value of the supply damper 40.

In this way, the feed amount of a liquid can be controlled with high accuracy in a liquid recovery system as well.

Further, because the above-described recovery pump is a metering pump, the liquid feed amount can be controlled with even higher accuracy.

The modified example, in which the supply pump 24A that is not a metering pump and the metering syringe 24B and the linear actuator 24C are used instead of the supply pump 24 that is a metering pump, may be applied to the above-described ink recovery system. Due thereto, the feed amount of the liquid can be controlled with high accuracy, and costs can be reduced.

A case is described above in which information that includes, in addition to the slack region of the elastic film 44 shown as an example in FIG. 10A and FIG. 10B, the adjacent regions therebefore and thereafter, is used as the initial elasticity curve information, and, in the adjustment value deriving processing, the output voltage values of the pressure sensor 43 are measured for all of these regions, and the adjustment values α′ and β′ are derived. However, the present invention is not limited to the same. For example, information corresponding only to the slack region of the elastic film 44 may be used as the initial elasticity curve information, and the output voltage values of the pressure sensor 43 only in that region may be measured and the adjustment values α′ and β′ derived. In this case, although the elastic film state detecting function cannot be implemented, the adjustment value deriving processing can be executed in a short time period.

Instead of the initial elasticity curve information, it is possible to use only pressure values corresponding to the feed amounts of predetermined two points, or one point only, at the slack region.

In a case of using pressure values corresponding to the feed amounts of two points, the adjustment values α′ and β′ can be obtained by substituting the pressure values p₁ and p₂ and the voltage values V₁′ and V₂′ corresponding to these two points into formula (6) and formula (7). In a case of using a pressure value corresponding to the feed amount of only one point, the adjustment values can be obtained by computing the offset amount between that pressure value and the pressure value expressed by the voltage value obtained from the pressure sensor 43 in the case of that feed amount.

In these cases, the size of the initial elasticity curve information and the measured voltage information can be made to be much smaller. Therefore, a reduction in the storage capacity for storing these information and a shortening of the time required to obtain these information can be realized.

A case is described above in which the elastic film state detecting processing program is executed only for the elastic film 44 provided at the supply damper 40, but the present invention is not limited to the same. For example, the elastic film state detecting processing program may be executed also for the elastic film 54 provided at the recovery damper 50 shown in FIG. 9. In this case as well, effects that are similar to those of the above-described exemplary embodiment can be exhibited.

Although a case is described above in which ink is employed as the liquid, the present invention is not limited to the same. For example, processing liquids for accelerating the aggregating of the ink or for suppressing the occurrence of blurring on a recording medium due to the ink can be employed as the liquid of the present invention. In such cases as well, effects that are similar to those of the above-described exemplary embodiment can be exhibited.

Although a case is described above in which a sensor that outputs a voltage value expressing the results of detection is used as the pressure sensor, the present invention is not limited to the same. A pressure sensor that outputs the detected pressure value itself may be used. The differences between pressure values included in the initial elasticity curve information and pressure values outputted from the pressure sensor, which pressure values correspond to common feed amounts, may be derived as the adjustment values. In this case, as compared with the above-described exemplary embodiment, the processing for deriving the adjustment values can be simplified, and the speed of executing the adjustment value deriving processing program can thereby be accelerated.

Embodiments of the present invention are described above, but the present invention is not limited to the embodiments as will be clear to those skilled in the art.

What is claimed is:

1. A liquid supply device comprising:
a storage tank temporarily storing liquid to be supplied to a predetermined supply destination;
an elastic film that is elastically-deformable and demarcates an interior of the storage tank into a liquid chamber that stores the liquid and an air chamber into which air is filled;
a pressure sensor detecting pressure within the liquid chamber;
a supply pump supplying the liquid to the supply destination via the liquid chamber;
a controller that, when the liquid is supplied to the supply destination by the supply pump, adjusts pressure detected by the pressure sensor by adjustment values that are derived in advance, and controls the supply pump such that an adjusted pressure becomes constant at a predetermined pressure; and
a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film,
wherein the controller controls the supply pump such that there becomes a supply amount that is substantially the same as a supply amount of the first information, and acquires, as second information, a pressure detected by the pressure sensor at that time, and derives the adjustment values on the basis of an offset amount between pressures of the first information and the second information.

2. The liquid supply device of claim 1, wherein the supply pump includes a metering pump.

3. The liquid supply device of claim 1, further comprising a metering unit that is disposed between the supply pump and the storage tank, and that makes a feed amount per predetermined time of liquid supplied by the supply pump be uniform at a preset amount.

4. The liquid supply device of claim 1, wherein
the pressure sensor is a sensor that outputs a voltage expressing a detected pressure,
the first information is information that includes the supply amounts of at least two points and pressures of the liquid chamber that correspond to those supply amounts,
the controller derives, as the adjustment values, α′ and β′ that are obtained by the following calculation formulas, where pressures of the liquid chamber corresponding to the two supply amounts in the first information are p₁ and p₂, and voltages outputted from the pressure sensor and corresponding to the two supply amounts in the second information are V₁′ and V₂′:
$$\begin{matrix}{α}^{′} = \frac{{p}_{1} - {p}_{2}}{{V}_{1}^{′} - {V}_{2}^{′}} \\ {β}^{′} = {p}_{1} - \frac{{p}_{1} - {p}_{2}}{{V}_{1}^{′} - {V}_{2}^{′}} {V}_{1}^{′}\end{matrix}$$
and the controller adjusts pressure of the liquid chamber detected by the pressure sensor by substituting the derived adjustment values α′ and β′ into the following calculation formula, where a voltage detected by the pressure sensor is V and a pressure corresponding to that voltage V is p:
p=α′V+β′.

5. The liquid supply device of claim 1, further comprising:
a second storage tank recovering, from the supply destination, and temporarily storing liquid except for liquid consumed by the supply destination;
a second elastic film that is elastically-deformable and demarcates an interior of the second storage tank into a liquid chamber that stores the liquid and an air chamber into which air is filled;
a second pressure sensor detecting pressure within the liquid chamber of the second storage tank; and
a recovery pump recovering the liquid via the liquid chamber of the second storage tank,
wherein the memory also stores in advance third information that expresses a recovery amount per predetermined time of the liquid by the recovery pump and a pressure of the liquid chamber of the second storage tank at a time when the liquid is recovered at that recovery amount, within a range of not being affected by changes over time in the second elastic film, and
when the liquid is recovered by the recovery pump, the controller adjusts pressure detected by the second pressure sensor by second adjustment values that are derived in advance, and controls the recovery pump such that an adjusted pressure becomes constant at a second pressure that is lower than the predetermined pressure, and, when deriving the second adjustment values, the controller controls the recovery pump such that there becomes a recovery amount that is substantially the same as a recovery amount included in the third information, and acquires, as fourth information, a pressure detected by the second pressure sensor at that time, and derives the second adjustment values on the basis of an offset amount between pressures of the third information and the fourth information.

6. The liquid supply device of claim 5, wherein the recovery pump includes a metering pump.

7. The liquid supply device of claim 5, further comprising a second metering unit that is disposed between the recovery pump and the second storage tank, and that makes a feed amount per predetermined time of liquid recovered by the recovery pump be uniform at a preset amount.

8. The liquid supply device of claim 5, wherein
the second pressure sensor is a sensor that outputs a voltage expressing a detected pressure,
the third information includes the recovery amounts of at least two points and pressures of the liquid chamber of the second storage tank that correspond to those recovery amounts,
the controller derives, as the adjustment values, α₂′ and β₂′ that are obtained by the following calculation formulas, where pressures of the liquid chamber of the second storage tank corresponding to the recovery amounts of the two points in the third information are p₃ and p₄, and voltages outputted from the second pressure sensor and corresponding to the recovery amounts of the two points in the fourth information are V₃′ and V₄′:
$$\begin{matrix}{α}_{2}^{′} = \frac{{p}_{3} - {p}_{4}}{{V}_{3}^{′} - {V}_{4}^{′}} \\ {β}_{2}^{′} = {p}_{3} - \frac{{p}_{3} - {p}_{4}}{{V}_{3}^{′} - {V}_{4}^{′}} {V}_{3}^{′}\end{matrix}$$
and the controller adjusts pressure detected by the second pressure sensor by substituting the derived adjustment values α₂′ and β₂′ into the following calculation formula, where a voltage detected by the second pressure sensor is V₂ and a pressure corresponding to that voltage V₂ is p₂:
p₂=α₂′V₂+β₂′.

9. The liquid supply device of claim 1, wherein the controller derives the adjustment values at a predetermined timing.

10. A liquid supply device comprising:
a storage tank temporarily storing liquid to be supplied to a predetermined supply destination;
an elastic film that is elastically-deformable and demarcates an interior of the storage tank into a liquid chamber that stores the liquid and an air chamber into which air is filled;
a pressure sensor detecting pressure within the liquid chamber;
a supply pump supplying the liquid to the supply destination via the liquid chamber;
a controller that, when the liquid is supplied to the supply destination by the supply pump, controls the supply pump such that a pressure detected by the pressure sensor becomes constant at a predetermined pressure;
a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount;
an acquisition unit acquiring elasticity curve information that includes a range that is not affected by changes over time in the elastic film and ranges that are affected, by acquiring a pressure detected by the pressure sensor at a time when the supply amount per predetermined time of the liquid by the supply pump is changed;
a detection unit detecting, as second inflection points, boundary points between the range that is not affected by changes over time in the elastic film and the ranges that are affected, from the elasticity curve information acquired by the acquisition unit; and
a specifying unit specifying a state of changes over time in the elastic film, on the basis of a state of offset between the first inflection points and the second inflection points.

11. An image forming device comprising
a liquid supply device that comprises:
a storage tank temporarily storing liquid to be supplied to a predetermined supply destination;
an elastic film that is elastically-deformable and demarcates an interior of the storage tank into a liquid chamber that stores the liquid and an air chamber into which air is filled;
a pressure sensor detecting pressure within the liquid chamber;
a supply pump supplying the liquid to the supply destination via the liquid chamber;
a controller that, when the liquid is supplied to the supply destination by the supply pump, adjusts pressure detected by the pressure sensor by adjustment values that are derived in advance, and controls the supply pump such that an adjusted pressure becomes constant at a predetermined pressure; and
a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film,
wherein the controller controls the supply pump such that there becomes a supply amount that is substantially the same as a supply amount of the first information, and acquires, as second information, a pressure detected by the pressure sensor at that time, and derives the adjustment values on the basis of an offset amount between pressures of the first information and the second information.

12. An image forming device comprising
a liquid supply device that comprises:
a storage tank temporarily storing liquid to be supplied to a predetermined supply destination;
an elastic film that is elastically-deformable and demarcates an interior of the storage tank into a liquid chamber that stores the liquid and an air chamber into which air is filled;
a pressure sensor detecting pressure within the liquid chamber;
a supply pump supplying the liquid to the supply destination via the liquid chamber;
a controller that, when the liquid is supplied to the supply destination by the supply pump, controls the supply pump such that a pressure detected by the pressure sensor becomes constant at a predetermined pressure;
a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount;
an acquisition unit acquiring elasticity curve information that includes a range that is not affected by changes over time in the elastic film and ranges that are affected, by acquiring a pressure detected by the pressure sensor at a time when the supply amount per predetermined time of the liquid by the supply pump is changed;
a detection unit detecting, as second inflection points, boundary points between the range that is not affected by changes over time in the elastic film and the ranges that are affected, from the elasticity curve information acquired by the acquisition unit; and
a specifying unit specifying a state of changes over time in the elastic film, on the basis of a state of offset between the first inflection points and the second inflection points.

13. A computer readable medium storing a program causing a liquid supply device to execute a process, the liquid supply device comprising: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film, the process comprising:
controlling the supply pump such that there becomes a supply amount that is substantially the same as a supply amount of the first information, and acquiring, as second information, a pressure detected by the pressure sensor at that time;
deriving adjustment values in accordance with an offset amount between pressures of the first information and the second information;
when the liquid is supplied to the supply destination by the supply pump, adjusting pressure detected by the pressure sensor by the adjustment values; and
controlling the supply pump such that a pressure after adjustment becomes constant at a predetermined pressure.

14. A computer readable medium storing a program causing a liquid supply device to execute a process, the liquid supply device comprising: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount, the process comprising:
acquiring elasticity curve information that includes a range that is not affected by changes over time in the elastic film and ranges that are affected, by acquiring a pressure detected by the pressure sensor at a time when the supply amount per predetermined time of the liquid by the supply pump is changed;
detecting, as second inflection points, boundary points between the range that is not affected by changes over time in the elastic film and the ranges that are affected, from the acquired elasticity curve information; and
specifying a state of changes over time in the elastic film, on the basis of a state of offset between the first inflection points and the second inflection points.

15. A computer readable medium storing a program causing a computer to execute a process, the computer controlling a liquid supply device, the liquid supply device comprising: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory in which is stored in advance first information that expresses a supply amount per predetermined time of the liquid by the supply pump and a pressure of the liquid chamber at a time when the liquid is supplied at that supply amount, within a range of not being affected by changes over time in the elastic film, the process comprising:
controlling the supply pump such that there becomes a supply amount that is substantially the same as a supply amount of the first information, and acquiring, as second information, a pressure detected by the pressure sensor at that time;
deriving adjustment values in accordance with an offset amount between pressures of the first information and the second information;
when the liquid is supplied to the supply destination by the supply pump, adjusting pressure detected by the pressure sensor by the adjustment values; and
controlling the supply pump such that a pressure after adjustment becomes constant at a predetermined pressure.

16. A computer readable medium storing a program causing a computer to execute a process, the computer controlling a liquid supply device, the liquid supply device comprising: a storage tank temporarily storing liquid to be supplied to a predetermined supply destination; an elastic film that is elastically-deformable and demarcates an interior of the storage tank into a liquid chamber that stores the liquid and an air chamber into which air is filled; a pressure sensor detecting pressure within the liquid chamber; a supply pump supplying the liquid to the supply destination via the liquid chamber; and a memory that stores in advance, as first inflection points, boundary points between a range that is not affected by changes over time in the elastic film and ranges that are affected, in an elasticity curve that expresses a relationship between a supply amount per predetermined time of the liquid by the supply pump and a pressure of the liquid chamber at a time when the liquid is supplied at that supply amount, the process comprising:
acquiring elasticity curve information that includes a range that is not affected by changes over time in the elastic film and ranges that are affected, by acquiring a pressure detected by the pressure sensor at a time when the supply amount per predetermined time of the liquid by the supply pump is changed;
detecting, as second inflection points, boundary points between the range that is not affected by changes over time in the elastic film and the ranges that are affected, from the acquired elasticity curve information; and
specifying a state of changes over time in the elastic film, on the basis of a state of offset between the first inflection points and the second inflection points.
